(19) United States
(12) Patent Application Publication
(10) Pub. No.: US 2007/0247444 A1
(43) Pub. Date: Oct. 25, 2007

(54) Method for measuring pressure resistance of touch panel

(75) Inventor: Shang-Tai Yeh, Sijhih City (TW)

Correspondence Address: TROXELL LAW OFFICE PLLC, SUITE 1404, 5205 LEESBURG PIKE, FALLS CHURCH, VA, 22041, US

(73) Assignee: eGalax Inc.

(21) Appl. No.: 11/407,213

(22) Filed: Apr. 20, 2006

(51) Int. Cl. G06F 3/045

(52) U.S. Cl. 345/174

(57) ABSTRACT

The present invention is related to a method for measuring pressure resistance of a touch panel. A reference resistor Rr is added to a measurement terminal which is coupled with a X-axis of a glass substrate of the touch panel. When users touch the touch panel, the touch point is where the glass substrate (X-axis) is electrically in contact with the outer layer (Y-axis). Because current I flowing through the reference resistor Rr and a touch point resistance Rt are equal; a voltage Va across the reference resistor Rr and a voltage Vb across the touch point resistance Rt are given, it is easy to calculate resistance of the touch point. The method of the present invention can be implemented by firmware so that it is fast, simple and accurate to calibrate the touch screen of the touch panel.

### FIELD OF THE INVENTION

The present invention relates to a method for measuring pressure resistance of a touch panel, and in particular, to a method suited to measure pressure resistance of a resistive touch panel.

### BACKGROUND OF THE INVENTION

Structure of conventional resistive touch panel is simple. An outer layer, is made of polyester. An inner surface of the outer layer is coated with a conductive metallic film, and a glass substrate coated with conductive material is disposed below the outer layer and the conductive metallic film. X-axis is positioned along the peripheral of the glass substrate, and Y-axis is positioned along the peripheral of the outer layer. When users' fingers touch the touch panel, a minute voltage is generated and a controller in the vicinity of the conductive metallic film is used to calculate X and Y coordinates of a touch point so that the touch point will be displayed on the touch screen of the touch panel. Advantage of the resistive touch panel is that a very thin and sensitive film is attached to a cathode ray tube or a liquid crystal display. However, light transmittance of components of the touch panel is low so that brightness and clarity are low. In addition, tolerance of X- and Y-axis leads to precision of the touch panel in a long period of service.

Because tolerance of X- and Y-axis has adverse impact on precision of the touch panel, a variety of calibration methods for the touch panel are utilized to correct the tolerance. Frequently used calibration method is shown in FIG. 1. FIG. 1 illustrates a block diagram of a method for measuring pressure resistance of a conventional touch panel. Pressure resistances of X- and Y-axis are calculated by measurement instrument. In addition, pressure resistance of the touch point is calculated using one of the following equations to calibrate the touch panel.

The equations are in the following:

$$Rtouch = Rx\_plate \cdot \frac{X\_Position}{4096} ( \frac{{Z}_{2}}{{Z}_{1}} - 1 )$$

or

$$Rtouch = \frac{Rx\_plate \cdot X\_Position}{4096} ( \frac{4096}{{Z}_{1}} - 1 ) - Ry\_plate \cdot \frac{Y\_Position}{4096}$$

However, resistance of the touch point is calculated using the above equations before resistance of X- and Y-axis is obtained by measurement instrument.

Thus, there is a need for a method for measuring pressure resistance of a touch panel.

### SUMMARY OF THE INVENTION

It is an object of the present invention to provide a method for measuring pressure resistance of a touch panel. The method is used to obtain related data of the touch panel using a simple calculation.

It is another object of the present invention to provide a method for measuring pressure resistance of a touch panel. The method is implemented by a firmware or circuit board so that it is more accurate and simple to calibrate the touch panel.

To achieve object of the present invention, a reference resistor Rr is added to a measurement terminal which is coupled with a X-axis of a glass substrate of the touch panel. When users touch the touch panel, the touch point is where the glass substrate (X-axis) is electrically in contact with the outer layer (Y-axis). Because currents flowing through the reference resistor Rr and a touch point resistance Rt are equal. In addition, voltage Va across the reference resistor Rr and voltage Vb across the touch point resistance Rt are given, so it is easy to calculate resistance of the touch point.

### BRIEF DESCRIPTION OF THE DRAWINGS

The present invention can be fully understood from the following detailed description and preferred embodiment with reference to the accompanying drawings, in which:

FIG. 1 is a block diagram of a method for measuring pressure resistance of a conventional touch panel; and

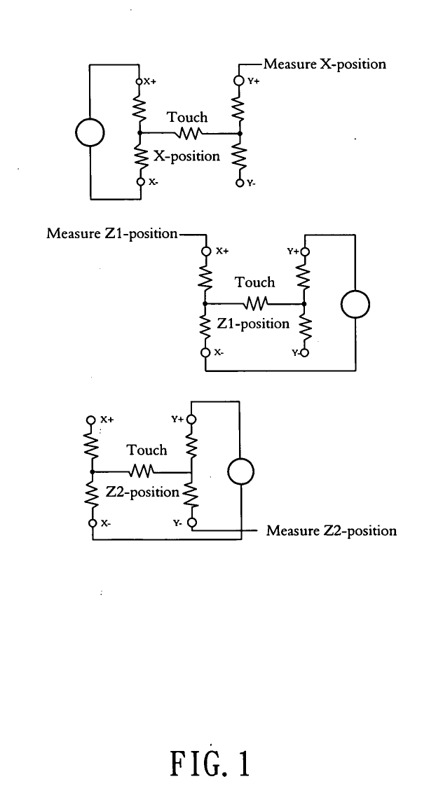

FIG. 2 is a block diagram of a method for measuring pressure resistance of a touch panel according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

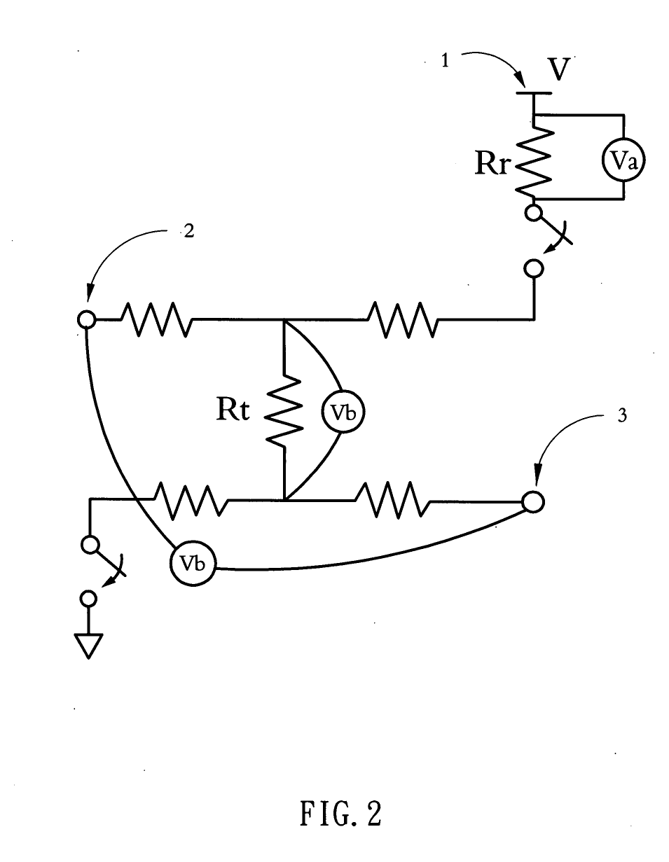

Reference is made to FIG. 2. FIG. 2 illustrates a block diagram of a method for measuring pressure resistance of a touch panel according to the present invention. According to the present invention, a reference resistor Rr is added to a measurement terminal 1 which is electrically coupled with a X-axis 2 of a glass substrate of the touch panel. When users touch the touch panel, the touch point is where the glass substrate (X-axis 2) is electrically in contact with an outer layer (Y-axis 3). Because currents I flowing through the reference resistor Rr and a touch point resistance Rt are equal. In addition, voltage Va across the reference resistor Rr and voltage Vb across the touch point resistance are given, so it is easy to calculate the touch point resistance Rt using the following equations:
Va=I×Rr (a)
Vb=I×Rt (b)

Divide equation (b) by equation (a):

$$\frac{Vb}{Va} = \frac{I \times Rt}{I \times Rr} = \frac{Rt}{Rr}$$

Then,

$$Rt = \frac{Vb}{Va} \times Rr$$

The method for measuring pressure resistance of a touch panel can be implemented by firmware or circuit boards.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A method for measuring pressure resistance of a touch panel, the steps comprise:
adding a reference resistor Rr to a measurement terminal which is electrically coupled with a X-axis of a glass substrate of the touch panel; and
touching the touch panel, and the touch point being where the glass substrate (X-axis) is electrically in contact with an outer layer (Y-axis);
wherein currents I flowing through the reference resistor Rr and a touch point resistance Rt are equal and a voltage Va across the reference resistor Rr and a voltage Vb across the touch point resistance are given, so the touch point resistance Rt is obtained.

2. The method as claimed in claim 1, wherein the touch point resistance Rt is calculated by using the following equations:
Va=I×Rr (a)
Vb=I×Rt (b)
Divide equation (b) by equation (a):
$$\frac{Vb}{Va} = \frac{I \times Rt}{I \times Rr} = \frac{Rt}{Rr}$$
Then,
$$Rt = \frac{Vb}{Va} \times Rr$$
the voltage Va across the reference resistor Rr and the voltage Vb across the touch point resistance are given, so it is easy to calculate the touch point resistance Rt.

3. The method as claimed in claim 1, wherein the method can be implemented by firmware or circuit boards.
